(19) United States
(12) Patent Application Publication
(10) Pub. No.: US 2024/0315484 A1
(43) Pub. Date: Sep. 26, 2024

(54) COOKING APPLIANCE

(71) Applicant: FOSHAN SHUNDE MIDEA ELECTRICAL HEATING APPLIANCES MANUFACTURING CO., LTD., FOSHAN (CN)

(72) Inventors: Weigang LV, FOSHAN (CN); Zhaoqiang XUE, FOSHAN (CN); Yun YANG, FOSHAN (CN); Ruoyu MEI, FOSHAN (CN)

(21) Appl. No.: 18/577,671

(22) PCT Filed: Apr. 29, 2022
(86) PCT No.: PCT/CN2022/090784

§ 371 Date: Mar. 10, 2024

(30) Foreign Application Priority Data
Jul. 9, 2021 (CN) 202121570408.4

(51) Int. Cl. A47J 37/06; A47J 27/08

(52) U.S. Cl. CPC A47J 37/0641; A47J 27/0802

(57) ABSTRACT

Provided is a cooking appliance. The cooking appliance includes a pot assembly, a pot lid assembly, and a first food container and a second food container. The pot assembly defines an accommodation chamber and is provided with a heating assembly. The pot lid assembly is provided with a fan assembly. One of the first food container and the second food container is placed in the accommodating cavity. When the cooking appliance is in a first cooking mode, the first food container is placed in the accommodation chamber; and when the cooking appliance is in a second cooking mode, the second food container is placed in the accommodation chamber. The second food container has a cooking cavity in communication with the accommodation chamber.

### CROSS-REFERENCES TO RELATED APPLICATIONS

The present disclosure is a national phase application of International Application No. PCT/CN2022/090784, filed on Apr. 29, 2022, which claims priority to Chinese patent application No. 202121570408.4, filed on Jul. 9, 2021, the entireties of which are herein incorporated by reference.

### FIELD

The present disclosure relates to the field of kitchen appliance technologies, and more particularly, to a cooking appliance.

### BACKGROUND

Cooking appliances in the related art, such as air fryers, use heating components to heat air, and then use hot air to cook ingredients. However, existing cooking appliances still have problems such as uneven browning of a food material and a poor air-frying effect.

### SUMMARY

The present disclosure aims to solve at least one of the problems in the related art. To this end, an embodiment of the present disclosure provides a cooking appliance, which is capable of improving a browning effect of a food material.

The cooking appliance according to embodiments of the present disclosure has a first cooking mode and a second cooking mode. The cooking appliance includes a pot assembly, a pot lid assembly, and a first food container and a second food container. The pot assembly defines an accommodation chamber and is provided with a heating assembly. The pot lid assembly is provided with a fan assembly configured to drive air in the accommodation chamber to flow. One of the first food container and the second food container is placed in the accommodation chamber. In response to the cooking appliance being in the first cooking mode, the first food container is placed in the accommodation chamber; and in response to the cooking appliance being in the second cooking mode, the second food container is placed in the accommodation chamber, and the second food container has a cooking chamber in communication with the accommodation chamber.

In the cooking appliance according to the embodiments of the present disclosure, the switching of the cooking modes is realized by replacing the food container matching with the pot assembly with the first food container or the second food container, which helps to simplify a structure, a volume, and a weight of a pot lid for a user's more convenient operation. Furthermore, the two cooking modes are heated by a bottom-mounted heating assembly, dehydration and browning of food are more uniform with a bottom-mounted thermal source. In addition, the fan assembly helps to improve temperature uniformity and heating efficiency of various regions of the accommodation chamber and the second food container in the second cooking mode. Thus, a cooking and browning effect is improved.

Furthermore, the cooking appliance according to the above embodiments of the present disclosure may have additional features as follows.

According to some embodiments of the present disclosure, the second food container has a top opening that is opened and opposite to the fan assembly.

According to some embodiments of the present disclosure, in response to the second food container being placed in the accommodation chamber, an air duct is formed between the second food container and the pot assembly, the heating assembly being located in the air duct.

According to some embodiments of the present disclosure, the second food container has an air passing hole at a bottom wall of the second food container, the cooking chamber being in communication with the air duct through the air passing hole.

According to some embodiments of the present disclosure, the second food container includes a container body and a shelf. The container body has the cooking chamber. The air passing hole is formed at a bottom wall of the container body. The shelf is disposed in the cooking chamber and divides the cooking chamber into an upper chamber and a lower chamber.

According to some embodiments of the present disclosure, the air duct includes a first air duct located at a lower side of the bottom wall of the second food container and a second air duct located outside a peripheral wall of the second food container, the heating assembly is located in the first duct; and the heating assembly includes a first heating element configured to heat the first food container and/or the second food container.

According to some embodiments of the present disclosure, the heating assembly further includes a second heating element configured to heat the first food container and/or the second food container. The second heating element is disposed below the first heating element.

According to some embodiments of the present disclosure, the first heating element is an annular heating plate and surrounds the air passing hole.

According to some embodiments of the present disclosure, the annular heating plate is provided with an air guide rib at a lower surface of the annular heating plate. The air guide rib extends in a radial direction of the annular heating plate.

According to some embodiments of the present disclosure, the cooking appliance further includes an air guide member having a through hole. The annular heating plate surrounds the air guide member. The second food container is supported by at least one of the first heating element and the air guide member.

According to some embodiments of the present disclosure, the first heating element is connected to a bottom wall of the accommodation chamber through connection feet. The connection feet is arranged at intervals in a circumferential direction of the first heating element and surrounds the second heating element.

According to some embodiments of the present disclosure, the first food container has a bottom wall attached to the heating assembly.

According to some embodiments of the present disclosure, the pot lid assembly includes a first pot lid assembly and a second pot lid assembly which is provided with the fan assembly. In response to the cooking appliance being in the first cooking mode, the first pot lid assembly covers the pot assembly; and in response to the cooking appliance being in the second cooking mode, the second pot lid assembly covers the pot assembly.

According to some embodiments of the present disclosure, the second pot lid assembly has a transparent region.

According to some embodiments of the present disclosure, the first cooking mode is a pressure-cooking mode; and the second cooking mode is an air-frying mode.

Additional embodiments of present disclosure will be provided at least in part in the following description, or will become apparent in part from the following description, or can be learned from the practice of the embodiments of the present disclosure.

### BRIEF DESCRIPTION OF THE DRAWINGS

These and other embodiments of the present disclosure will become apparent and more readily appreciated from the following descriptions made with reference to the accompanying drawings.

FIG. 1 is an exploded view of a cooking appliance according to an embodiment of the present disclosure, where the cooking appliance is in a first cooking mode.

FIG. 2 is a cross-sectional view of a cooking appliance according to a first embodiment of the present disclosure, where the cooking appliance is in a first cooking mode.

FIG. 3 is an exploded view of a cooking appliance according to an embodiment of the present disclosure, where the cooking appliance is in a second cooking mode.

FIG. 4 is a cross-sectional view of a cooking appliance according to a first embodiment of the present disclosure, where the cooking appliance is in a second cooking mode;

FIG. 5 is a schematic view of an enlarged structure at circled A in FIG. 4.

FIG. 6 is a cross-sectional view of a cooking appliance according to a second embodiment of the present disclosure, where the cooking appliance is in a first cooking mode.

FIG. 7 is a cross-sectional view of a cooking appliance according to a second embodiment of the present disclosure, where the cooking appliance is in a second cooking mode.

FIG. 8 is a cross-sectional view of a cooking appliance according to a third embodiment of the present disclosure, where the cooking appliance is in a first cooking mode.

FIG. 9 is a cross-sectional view of a cooking appliance according to a third embodiment of the present disclosure, where the cooking appliance is in a second cooking mode.

### REFERENCE NUMERALS

cooking appliance 100;
pot assembly 10; accommodation chamber 101; fan opening 102; mounting hole 103; air duct 104; first air duct 105; second air duct 106; housing 11; outer pot 12;
heating assembly 20; first heating element 21; second heating element 22; air guide rib 23; connection foot 24;
fan assembly 30; fan 31; drive motor 32; motor shaft 33; heat dissipation fan impeller 34;
first food container 41; first cooking chamber 411; second food container 42; cooking chamber 421; air passing hole 422; shelf 423; container body 424;
air guide member 50; through hole 51;
first pot lid assembly 61; exhaust valve 611; second pot lid assembly 62; and transparent region 621.

### DETAILED DESCRIPTION OF THE DISCLOSURE

The embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain rather than limit the present disclosure.

In the description of the present disclosure, it is to be understood that, terms such as “center”, “longitudinal”, “lateral”, “length”, “width”, “thickness”, “over”, “below”, “front”, “back”, “left”, “right”, “vertical”, “horizontal”, “top”, “bottom”, “in”, “out”, “clockwise”, “counterclockwise”, “axial”, “radial”, “circumferential”, etc., is based on the orientation or position relationship illustrated in the drawings, and is only for the convenience of describing the present disclosure and simplifying the description, rather than indicating or implying that the associated device or element must have a specific orientation, or be constructed and operated in a specific orientation, and therefore cannot be understood as a limitation on the present disclosure.

In the description of the present disclosure, “first characteristic”, “second characteristic” may include one or more such characteristics, “a plurality of” means two or more than two, the first characteristic is “on” or “under” the second characteristic refers to the first characteristic and the second characteristic can be direct or via their another characteristic indirect mountings, connections, and couplings, and the first characteristic is “on”, “above”, “over” the second characteristic may refer to the first characteristic is right over the second characteristic or is diagonal above the second characteristic, or just refer to the horizontal height of the first characteristic is higher than the horizontal height of the second characteristic.

A cooking appliance 100 according to an embodiment of the present disclosure is described below with reference to the accompanying drawings.

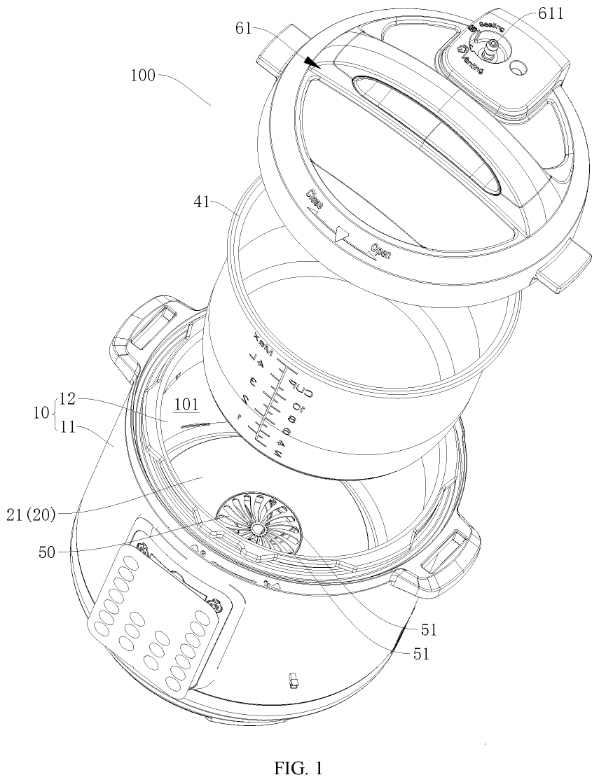

Referring to FIGS. 1 to 4, a cooking appliance 100 according to an embodiment of the present disclosure has a first cooking mode and a second cooking mode. The cooking appliance 100 includes a pot assembly 10, a heating assembly 20, a fan assembly 30, a first food container 41, and a second food container 42.

In an exemplary embodiment of the present disclosure, the pot assembly 10 defines an accommodation chamber 101, the first food container 41 is placed in the accommodation chamber 101 in response to the cooking appliance 100 being in the first cooking mode, and the second food container 42 is placed in the accommodation chamber 101 in response to the cooking appliance 100 being in the second cooking mode. In one embodiment, the pot assembly 10 is provided with the heating assembly 20, for example, the heating assembly 20 may be disposed in the accommodation chamber 101 and is configured to heat air or the food container in the accommodation chamber 101, and the food is cooked in the food container.

In some embodiments, when the first food container 41 is displaced in the accommodation chamber 101, the first food container 41 has a first cooking chamber 411 in no communication with the accommodation chamber 101 (i.e., a bottom wall and a side wall of the first food container 41 each are continuous walls), and the heating assembly 20 can increase a temperature of the first food container 41 by heating the first food container 41 and heat food in the first cooking chamber 411.

In some embodiments, when the second food container 42 is placed in the accommodation chamber 101, the second food container 42 has a second cooking chamber (i.e., a cooking chamber 421, hereinafter referred to as a second cooking chamber) which may be in communication with the accommodation chamber 101. For example, the second food container 42 may have an air passing hole 422 formed at least one of a top wall and a side wall of the second food container 42, or the second cooking chamber may be connected to the accommodation chamber 101 through a top opening of the second food container 42. Air heated by the heating assembly 20 in the accommodation chamber 101 may flow into the second cooking chamber to heat food in the second cooking chamber. Compared to a heat transfer mode of the first food container 41 by heat conduction, a way in which the food is directly heated by the hot air can improve uniformity of dehydration and browning of the food to achieve different cooking functions.

In addition, the fan assembly 30 can be configured to drive air in the accommodation chamber 101 to flow, to allow the air heated by the heating assembly 20 to flow into the second cooking chamber more quickly, and thus to further improve heating efficiency of the food in the second cooking chamber. In some embodiments, the second food container 42 is spaced apart from a chamber wall of the accommodation chamber 101 by a gap, and therefore an air duct 104 is formed between the second food container 42 and the pot assembly 10 to reduce resistance to flow of the air. The air can fully circulate and flow in the accommodation chamber 101 and the second cooking chamber to improve heating uniformity and heating efficiency of the food.

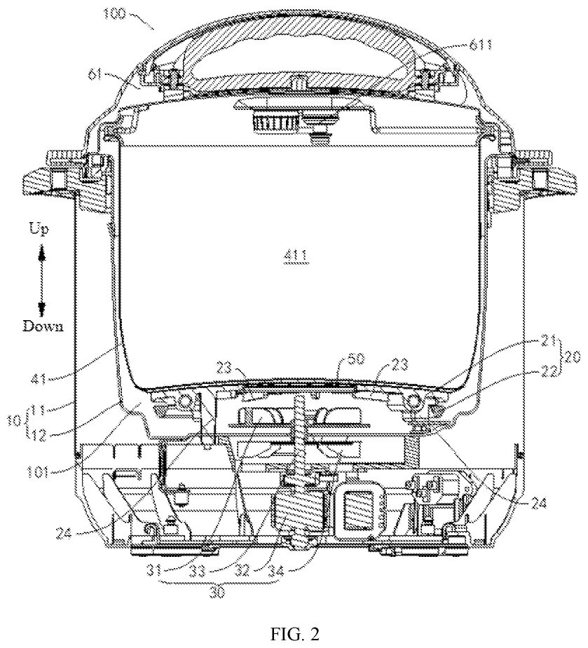

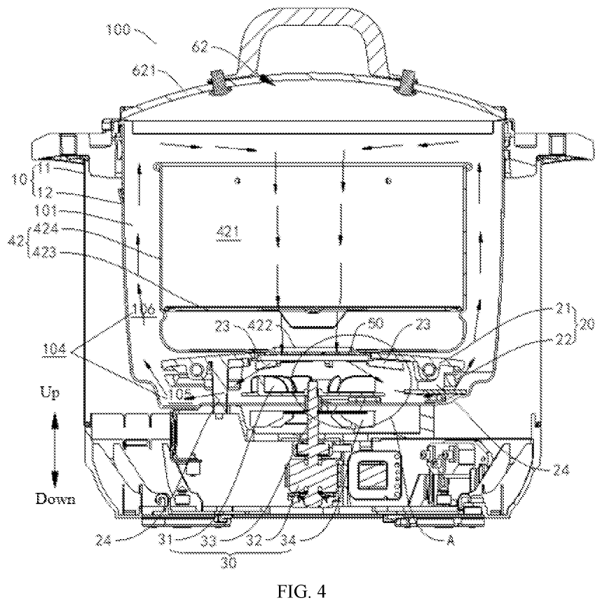

In some embodiments of the present disclosure, as illustrated in FIGS. 2 and 4, the air duct 104 includes a first air duct 105 disposed at a lower side of the bottom wall of the second food container 42 and a second air duct 106 disposed outside the side wall of the second food container 42, and the heating assembly 20 is located in the first air duct 105, i.e., located in a lower part of the accommodation chamber 101. When a food container (the first food container 41 or the second food container 42) is placed in the accommodation chamber 101, the heating assembly 20 is located below the food container to heat the food from a lower side. When the first food container 41 is placed in the accommodation chamber 101, as illustrated in FIG. 2, the first food container 41 has a bottom wall attached to the heating assembly 20, i.e., in face-to-face contact, which, on the one hand, can support and limit the first food container 41, and on the other hand, can increase efficiency of heat conduction between the first food container 41 and the heating assembly 20, and increase heating uniformity of the food in the first cooking chamber 411. When the second food container 42 is placed in the accommodation chamber 101, as illustrated in FIG. 4, the bottom wall of the second food container 42 and the heating assembly 20 may be in contact with each other to cooperate or spaced apart from each other by a gap. Air in the lower part of the accommodation chamber 101 has a natural upward tendency after being heated by the heating assembly 20, which helps to enhance circulation of an internal thermal field and achieve the heating uniformity of the food.

As illustrated in FIGS. 1, 2, 6, and 8, in the first cooking mode, the first food container 41 is placed in the accommodation chamber 101, and the heating assembly 20 operates to process the food such as steaming, simmering, boiling, etc.

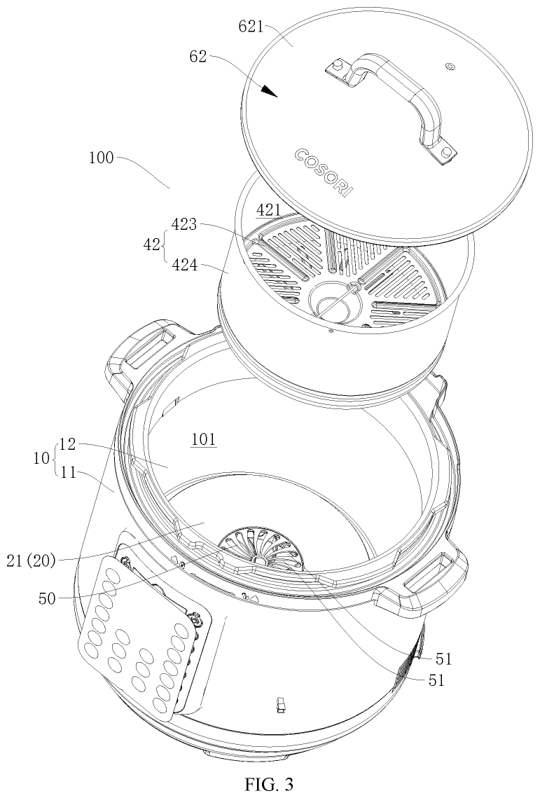

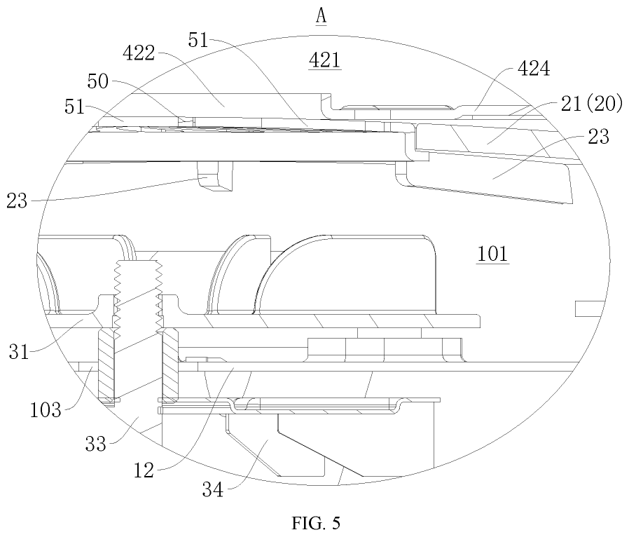

As illustrated in FIGS. 3 to 5, 7, and 9, in the second cooking mode, the second food container 42 is placed in the accommodation chamber 101, both the heating assembly 20 and a fan assembly 30 operates, and the second cooking chamber of the second food container 42 is in communication with the accommodation chamber 101 to allow the hot air to flow into the second cooking chamber for processing the food such as air frying, dehydration, etc.

By replacing the food container matching with the pot assembly 10 with the first food container 41 or the second food container 42, it is easy for the cooking appliance 100 to operate in different cooking modes, and the cooking appliance 100 can satisfy more cooking needs and realize different cooking effects.

In some exemplary embodiments of the present disclosure, the first cooking mode may be a pressure-cooking mode and the second cooking mode may be an air-frying mode. The cooking appliance 100 is formed as a pressure air-frying integrated machine, which has both pressure-cooking and air-frying modes, and is highly practical.

In the pressure-cooking mode, the heating assembly 20 can heat the food in the first food container 41 and can change an air pressure in the first cooking chamber 411 of the first food container 41 to form a positive pressure (i.e., the first cooking chamber 411 has a pressure greater than a pressure of an ambient environment). In the pressure-cooking mode, the food can be simmered, boiled, stewed, etc. In this way, the food can be cooked with high efficiency and better nutrient extraction.

In the air-frying mode, the heating assembly 20 can heat air in the accommodation chamber 101, and hot air flows into the second cooking chamber of the second food container 42 to realize processing of the food such as baking, frying, air frying, etc. In this way, the food is heated uniformly with a good baking effect.

In yet some embodiments of the present disclosure, the first cooking mode may also be a baking mode, a porridge mode, a soup mode, or a steaming mode, etc., and the second cooking mode may also be a baking mode, a porridge mode, a soup mode, or a steaming mode, etc. In one embodiment, the first cooking mode is different from the second cooking mode, and therefore the cooking appliance 100 may serve as an air fryer, a rice cooker, a soup cooker, a steamer, etc.

In the embodiments of the present disclosure, since heating is performed by the heating assembly 20 disposed in the accommodation chamber 101 in both the first cooking mode and the second cooking mode, there is no need to provide a heating structure at a pot lid assembly, which helps to simplify a structure of the pot lid assembly and reduce a number of components, a volume, and a weight of the pot lid assembly. In this way, a user's effort to pick up and place the pot lid assembly is saved. In one embodiment, the bottom-mounted thermal source is realized by the heating of the heating assembly 20, which facilitates more uniform browning of the food. In addition, in some embodiments, a same pot lid assembly can be used to match with the pot assembly 10 in the first cooking mode and the second cooking mode, i.e., there is no need to replace the pot lid assembly when switching the cooking modes, which is simpler for the user to operate.

In some exemplary embodiments, as illustrated in FIGS. 1, 2, 6, and 8, the cooking appliance 100 may include a first pot lid assembly 61. In response to the cooking appliance 100 being in the first cooking mode, the first pot lid assembly 61 may cover the pot assembly 10. Furthermore, a top opening of the first food container 41 may be closed by the first pot lid assembly 61 to allow the first cooking chamber 411 to be closed. When the first food container 41 is heated by the heating assembly 20, an air pressure in the first cooking chamber 411 may increase to allow for pressure cooking. For example, the first pot lid assembly 61 may include a lid body, an exhaust valve 611, and a seal ring. The seal ring is mounted at the lid body and sealingly engaged with an edge of the top opening of the first food container 41 to close the top opening of the first food container 41, and the exhaust valve 611 is disposed at the lid body and in communication with the first cooking chamber 411 to facilitate adjustment of the pressure in the first cooking chamber 411.

In response to the cooking appliance 100 being in the second cooking mode, the first pot lid assembly 61 may cover the pot assembly 10, and therefore there is no need to additionally provide a pot lid structure used in the second cooking mode. The first pot lid assembly 61 may be spaced apart from the top opening of the second food container 42 by a gap to allow the second cooking chamber to be connected to the air duct 104 through the top opening, facilitating circular flow of the hot air.

In some exemplary embodiments, as illustrated in FIGS. 3 to 5, 7, and 9, the cooking appliance 100 may further include a second pot lid assembly 62, and in response to the cooking appliance 100 being in the second cooking mode, the second pot lid assembly 62 may cover the pot assembly 10. Different pot lid assemblies are used in the first cooking mode and the second cooking mode respectively, which helps to increase a service life of the pot lid assembly and is easier to clean the pot lid assembly. For example, the exhaust valve 611 at the first pot lid assembly 61 is prevented from being clogged and contaminated during air frying. The second pot lid assembly 62, however, does not need to be provided with a complicated structure such as the exhaust valve 611, and can be directly rinsed with water. In this way, cleaning is more convenient.

In some embodiments, the second pot lid assembly 62 may also have a transparent region 621. The user can view a cooking state of the food in the second cooking chamber at any time through the transparent region 621, which facilitates user's usage and observation and is easy for the user to grasp a cooking degree of the food. In this way, user experience is improved. In an exemplary embodiment of the present disclosure, as illustrated in FIGS. 3 and 4, the second pot lid assembly 62 may include a lid plate and a handle. The handle is connected to the lid plate to facilitate picking up and placing of the second pot lid assembly 62. The lid plate may be a transparent glass plate, which facilitates observation by the user.

In the cooking appliance 100 according to the embodiments of the present disclosure, the switching of the cooking modes is realized by replacing the food container matching with the pot assembly 10 with the first food container 41 or the second food container 42, which helps to simplify a structure, a volume, and a weight of a pot lid for more convenient operation of the user. Furthermore, the two cooking modes are heated by the bottom-mounted heating assembly 20, dehydration and browning of food are more uniform with the bottom-mounted thermal source. In addition, the fan assembly 30 helps to improve temperature uniformity and heating efficiency of various regions of the accommodation chamber 101 and the second food container 42 in the second cooking mode. Thus, cooking efficiency is improved.

A mounting structure of each of the fan assembly 30 and the heating assembly 20 according to some embodiments of the present disclosure is described below with reference to the accompanying drawings.

In some embodiments of the present disclosure, as illustrated in FIGS. 2 and 4, the fan assembly 30 may be mounted at a bottom of the pot assembly 10. Operation of the fan assembly 30 may create a positive or negative pressure at a lower part of the accommodation chamber 101 (i.e., at the first air duct 105). Thus, the air flows throughout the entire accommodation chamber 101 and flows into and out of the second cooking chamber. The larger bottom mounting space of the pot assembly 10 facilitates the mounting of the fan assembly 30, which can improve space utilization and reduce a lateral dimension of the cooking appliance 100. In an embodiment where the heating assembly 20 is disposed in the lower part of the accommodation chamber 101, the fan assembly 30 is closer to the heating assembly 20, which can drive air around the heating assembly 20 to flow more adequately. The air heated by the heating assembly 20 can flow rapidly to a low-temperature region, which helps to improve the temperature uniformity in the accommodation chamber 101 and the second cooking chamber.

In an exemplary embodiment of the present disclosure, as illustrated in FIG. 4, the pot assembly 10 may include an outer pot 12 and a housing 11. The outer pot 12 is disposed in the housing 11, the outer pot 12 defines the accommodation chamber 101, and the outer pot 12 has a mounting hole 103 formed at a bottom the bottom wall of the outer pot 12. The fan assembly 30 may include a drive motor 32 and a fan 31. The fan 31 is located in the outer pot 12 and is located below the second food container 42. The drive motor 32 is located below the outer pot 12 and mounted at the housing 11. The drive motor 32 is provided with a motor shaft 33 passing through the mounting holes 103 and connected to the fan 31 to allow the drive motor 32 to drive the fan 31 to rotate, and thus to drive the air in the accommodation chamber 101 to circulate and flow.

In addition, as illustrated in FIG. 4, the fan assembly 30 may further include a heat dissipation fan impeller 34. The heat dissipation fan impeller 34 is mounted at the motor shaft 33 and is located below the bottom wall of the outer pot 12, and operation of the heat dissipation fan impeller 34 is able to drive air around the drive motor 32 to flow to dissipate heat of the drive motor 32, which ensures use safety.

In other embodiments of the present disclosure, the mounting structure of the fan assembly 30 includes, but is not limited to, the above. For example, in some other embodiments, the fan assembly 30 may be disposed between the bottom wall of the outer pot 12 and the housing 11, the outer pot 12 may have a fan opening 102 formed at the bottom wall of the outer pot 12, and at least part of the fan 31 may be at the fan opening 102. As a result, the fan 31, when rotating, may drive the air in the accommodation chamber 101 to flow through the fan opening 102.

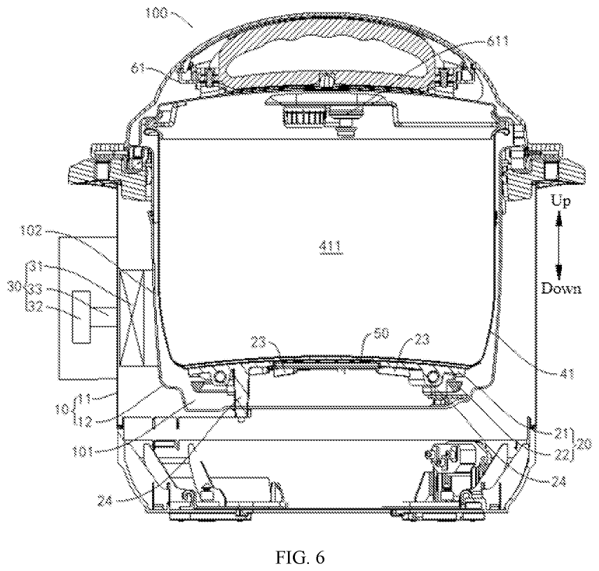

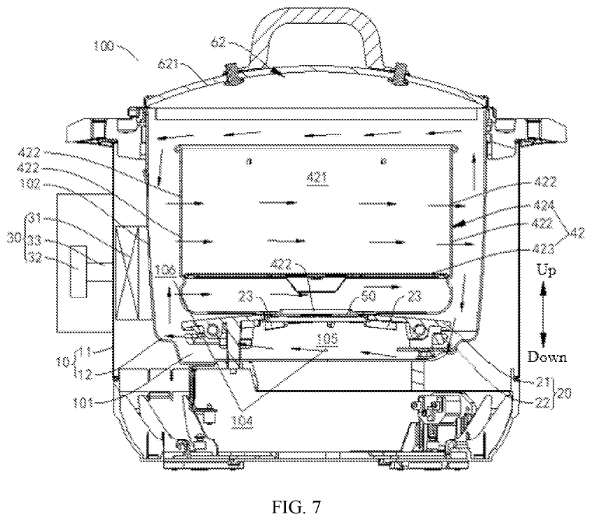

In some embodiments of the present disclosure, as illustrated in FIGS. 6 and 7, the fan assembly 30 may be mounted at a side of the pot assembly 10, and operation of the fan assembly 30 may create a positive or negative pressure at a side of the accommodation chamber 101 (i.e., at the second air duct 106). Thus, the air flows throughout the accommodation chamber 101 and flows into and out of the second cooking chamber. Driving the air to flow in the accommodation chamber 101 from the side of the accommodation chamber 101 facilitates more rapid circulation of the air in an upper part and a lower part of the accommodation chamber 101 and improves the temperature uniformity in the accommodation chamber 101 and the second cooking chamber. In the embodiment where the heating assembly 20 is disposed in the lower portion of the accommodation chamber 101, the upper part of the accommodation chamber 101 is farther away from the heating assembly 20, and the fan assembly 30 is located between the heating assembly 20 and a top of the accommodation chamber 101 in an up-down direction, which facilitates flow of the hot air from the lower part to the upper part of the accommodation chamber 101.

In an exemplary embodiment of the present disclosure, the pot assembly 10 may include an outer pot 12 and a housing 11. The outer pot 12 is disposed in the housing 11 and defines the accommodation chamber 101, and the outer pot 12 has a mounting hole formed at a sidewall of the outer pot 12. The fan assembly 30 may include a drive motor 32 and a fan 31. The fan 31 is located in the outer pot 12 and outside the second food container 42. The drive motor 32 is mounted in the housing 11, and the drive motor 32 is provided with a motor shaft 33 passing through the mounting hole and connected to the fan 31 to allow the drive motor 32 to drive the fan 31 to rotate, and thus to drive the air in the accommodation chamber 101 to circulate and flow. The drive motor 32 may be located outside the housing 11 to facilitate dissipation heat from the drive motor 32 or between the housing 11 and a side wall of the outer pot 12.

In other exemplary embodiments of the present disclosure, the mounting structure of the fan assembly 30 includes, but is not limited to, this. For example, in other embodiments, as illustrated in FIG. 7, the fan 31 may be disposed between the side wall of the outer pot 12 and the housing 11, and the outer pot 12 may have a fan opening 102 formed at the side wall of the outer pot 12, and at least part of the fan 31 may be at the fan opening 102. As a result, the fan 31, when rotating, may drive the air in the accommodation chamber 101 to flow through the fan opening 102.

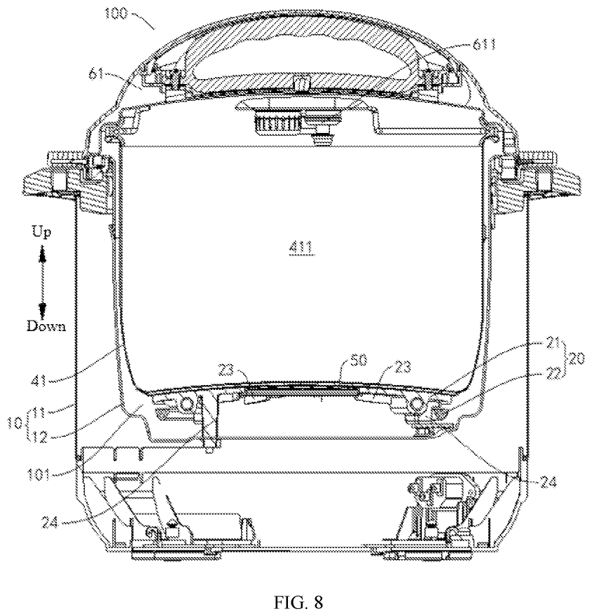

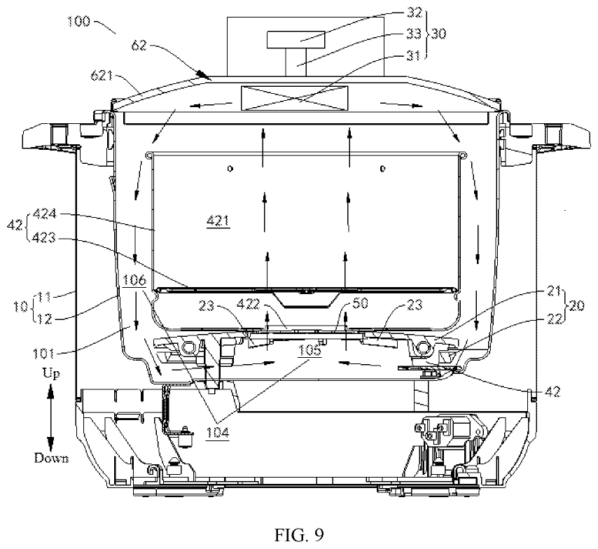

In some embodiments where the cooking appliance 100 includes a second pot lid assembly 62, as illustrated in FIGS. 8 and 9, the fan assembly 30 may be disposed in the pot lid assembly, such as in the second pot lid assembly 62, to drive the air in the accommodation chamber 101 to flow from an upper part of the accommodation chamber 101 and into and out of the second cooking chamber. In some embodiments, the second food container 42 has a top opening that is opened and opposite to the fan assembly 30 to allow the fan assembly 30 to directly drive air in the second cooking chamber to flow in and out of the second food container 42 through the top opening with less resistance to flow of the air. In the embodiment where the heating assembly 20 is disposed in the lower part of the accommodation chamber 101, the fan assembly 30 may create a positive or negative pressure to be formed in a region farther away from the heating assembly 20, to accelerate that hot air in a region closer to the heating assembly 20 can flow rapidly to the low-temperature region, and to realize the temperature uniformity in the accommodation chamber 101 and the second cooking chamber.

In some exemplary embodiments, as illustrated in FIG. 9, the second pot lid assembly 62 may include a lid plate and a handle, and the lid plate has a mounting hole. The fan assembly 30 includes a drive motor 32 and a fan 31. The fan 31 is located below the lid plate. The drive motor 32 is located outside the cover plate and mounted in the handle to facilitate the dissipation of the heat from the drive motor 32. The motor shaft 33 passes through the mounting hole to be connected to the fan 31.

According to some embodiments of the present disclosure, as illustrated in FIGS. 4, 7, and 9, the second food container 42 may have an air passing hole 422 formed at at least one of the side wall and the bottom wall of the second food container 42 to enable the second food container 42 to be formed as a frying basket. The cooking chamber being in communication with the air duct 104 through the air passing hole 422, to accelerate air interaction between the air duct 104 and the second cooking chamber, and thus to increase the heating efficiency of the food in the second cooking chamber.

In some exemplary embodiments, as illustrated in FIGS. 4 and 9, the second food container 42 has the air passing holes 422 formed at the bottom wall of the second food container 42, and driven by the fan assembly 30, air in the air duct 104 may flow into the second cooking chamber through the air passing hole 422 and then return to the air duct 104 through the top opening of the second cooking chamber, or air in the air duct 104 may flow into the second cooking chamber through the top opening of the second cooking chamber and then return to the air duct 104 through the air passing hole 422. Thus, the circular flow of the air is realized. And the air passing hole 422 is opposite to the top opening of the second cooking chamber to allow the air to flow through a wider region of the second cooking chamber, improving the heating uniformity of the food in each region.

In still yet some exemplary embodiment, as illustrated in FIG. 7, the side wall of the second food container 42 has air passing holes 422, and at least two of the air passing holes 422 are opposite to each other (as illustrated in FIG. 7, some of the air passing holes 422 are formed at a left side of the second cooking chamber, and some of the air passing holes 422 are formed at a right side of the second cooking chamber), and the air in the air duct 104 can flow into and out of the second cooking chamber through the opposite air passing holes 422 to uniformly heat the food in various regions of the second cooking chamber.

In some embodiments where the fan assembly 30 includes a fan 31, the fan 31 may be opposite to the air passing hole 422 as illustrated in FIGS. 4 and 7, or the fan 31 may be opposite the top opening of the second cooking chamber as illustrated in FIG. 9, to increase efficiency of the air flowing into and out of the second cooking chamber through the air passing hole 422 or the top opening, and thus to improve the effect of the circular flow of the air.

In some embodiments, the heating assembly 20 may include a heating element that operates in both the first cooking mode and the second cooking mode to heat the first food container 41 and the second food container 42.

In other embodiments, the heating assembly 20 may include heating elements, with at least one heating element operating in the first cooking mode and at least one heating element operating in the second cooking mode. For example, the heating assembly 20 may include a first heating element 21 and a second heating element 22. In the first cooking mode, the first heating element 21 operates to heat the first food container 41; and in the second cooking mode, at least one of the first heating element 21 and the second heating element 22 operates to heat the second food container 42.

In some embodiments of the present disclosure, as illustrated in FIGS. 3 to 5 and 9, the second heating element 22 may be an annular heating pipe. In an embodiment where the fan assembly 30 is disposed at the bottom of the pot assembly 10, the annular heating pipe may surround the fan assembly, and therefore the fan 31 of the fan assembly 30, when rotating, may blow air towards the annular heating pipe to allow air in the first air duct 105 to uniformly flow into the second air duct 106 after being heated by the annular heating pipe, or may drive air in the second air duct 106 to uniformly blow towards the annular heating pipe to flow into the first air duct 105 after being heated by the annular-shaped heating pipe. In this way, circumferential heating uniformity is improved.

In an embodiment where the second food container 42 has the air passing hole 422 at the bottom wall of the second food container 42, as illustrated in FIG. 4, the second heating element 22 may surround the air passing hole 422 at the bottom wall of the second food container 42 to allow the air passing through the air passing hole 422 to be uniformly heated by the second heating element 22, which improves the circumferential heating uniformity and the heating efficiency.

In the embodiment where the second food container 42 has the air passing hole 422 at the bottom wall of the second food container 42, the first heating element 21 may have a ventilation hole, and the air passing hole 422 is in communication with the first air duct 105 through the ventilation hole. In one embodiment, as illustrated in FIGS. 3 to 5 and 9, the first heating element 21 may be an annular-shaped heating plate which may surround the air passing hole 422 at the bottom wall of the second food container 42 to avoid blocking the air passing hole 422 and to allow for smooth communication between the air passing hole 422 and the first air duct 105.

In some embodiments, as illustrated in FIGS. 3 to 5 and 9, the annular-shaped heating plate may be provided with an air guide rib 23 at a lower surface of the annular-shaped heating plate, and the air guide rib 23 extends in a radial direction of the annular-shaped heating plate. In the embodiment where the second food container 42 has the air passing hole 422 at the bottom wall of the second food container 42, the air guide rib 23 may guide air located at a lower side of the first heating element 21 to allow the air to flow from a periphery of the accommodation chamber 101 towards the air passing hole 422 in the bottom wall of the second food container 42, or from the air passing hole 422 at the bottom wall of the second food container 42 towards the periphery of the accommodation chamber 101. In this way, distribution uniformity of the hot air anywhere in the circumferential direction is easily improved.

In some embodiments, as illustrated in FIGS. 3 to 5 and 9, the cooking appliance 100 may also include an air guide member 50. The air guide member 50 has a through hole 51, and the annular-shaped heating plate may surround the air guide member 50. The air guide member 50 not only ensures the smooth air circulation, but also can shield a component below the first heating element 21, such as shielding the fan assembly 30, to avoid accidental injury by a user touching the fan assembly 30 when the food container is removed.

In some embodiments, as illustrated in FIGS. 3 and 4, through holes 51 may be provided and arranged around a centerline of the accommodation chamber 101 to increase airflow. Air guide ribs 23 may be provided and arranged around the centerline of the accommodation chamber 101 to further improve uniformity of the airflow anywhere in the circumferential direction of the accommodation chamber 101.

In some embodiments, as illustrated in FIG. 4, the second food container 42 may be supported by at least one of the air guide member 50 and the first heating element 21 to fix the second food container 42, and communication between the air passing hole 422 and the through hole 51 is highly effective, which is easy to reduce the resistance to the air.

According to some embodiments of the present disclosure, as illustrated in FIG. 4, the first heating element 21 may be connected (fixedly connected or support fit) to a bottom wall of the accommodation chamber 101 through connection feet 24 to allow the first heating element 21 to be spaced apart from the bottom wall of the accommodation chamber 101 by a gap, which ensures the smooth flow of the air in the first air duct 105, and the connection feet 24 is arranged at intervals in a circumferential direction of the first heating element 21 to allow the first air duct 105 to be connected to the second air duct 106 through a gap between two adjacent connection feet 24.

In addition, the connection feet 24 may surround the second heating element 22 to fix the second heating element 22, and the second heating element 22 may be spaced apart from the bottom wall of the accommodation chamber 101 by a gap to ensure the smooth flow of the air in the first air duct 105.

In some embodiments, as illustrated in FIGS. 3 and 4, the second food container 42 includes a container body 424 and a shelf 423. The container body 424 has a second cooking chamber, and the air passing hole 422 is formed at at least one of a bottom wall and a side wall of the container body 424. The shelf is disposed in the second cooking chamber and divides the cooking chamber into an upper chamber and a lower chamber. The upper chamber can be configured to place food to space the food from the bottom wall of the second food container 42, avoiding affecting the air-frying effect due to excessively localized heating of the food and avoiding the food from clogging the air passing holes 422. The shelf 423 may have through holes, and the upper chamber is in communication with the lower chamber through the through holes.

An operation state of the heating assembly 20 in the first cooking mode and the second cooking mode according to some embodiments of the present disclosure is described below with reference to the accompanying drawings.

In an embodiment where the heating assembly 20 includes only one heating element, such as a first heating element 21, the first heating element 21 operates in response to the cooking appliance 100 being in the first cooking mode and the second cooking mode. The two cooking modes are heated by a same heating element, which helps to reduce a number of parts and cost.

As illustrated in FIGS. 2 and 4 to 9, the heating assembly 20 includes two heating elements, such as a first heating element 21, and a second heating element 22. The second heating element 22 is disposed below the first heating element 21. In response to the cooking appliance 100 being in the first cooking mode, the first heating element 21 operates, but the second heating element 22 does not operate, and therefore the first heating element 21, which is closer, can sufficiently exchange heat with the first food container 41 to improve the cooking efficiency and cooking effect. In response to the cooking appliance 100 being in the second cooking mode, the first heating element 21 does not operate, but the second heating element 22 operates, and therefore the operating heating element is farther away from the second food container 42, which facilitates full contact with the air in the air duct 104 and avoids affecting the cooking effect due to excessively localized heating of the wall surface of the second food container 42.

In one embodiment, the first heating element 21 and the second heating element 22 are used in different cooking modes respectively, and therefore shapes, control logics, etc., of the first heating element 21 and the second heating element 22 may be set separately without affecting each other, reducing a design difficulty and improving a cooking control effect. For example, the first heating element 21 may include a heat exchanger plate in face-to-face contact with a bottom wall surface of the first food container 41 to improve the heating uniformity and heat exchange efficiency; and the second heating element 22 may be a heating pipe, which has a larger surface area to be in full contact with the air for heat exchange, improving the air frying efficiency.

In an embodiment where the first heating element 21 and the second heating element 22 are used in different cooking modes respectively, the first heating element 21 may be mounted at the pot assembly 10 to reduce a weight of the first food container 41, and to facilitate cleaning and picking up and placing of the first food container 41. In one embodiment, the first heating element 21 may be mounted in the first food container 41. When the first food container 41 is placed in the accommodation chamber 101, the first heating element 21 is located in the accommodation chamber 101. When the first food container 41 is removed, the first heating element 21 may be removed together, which is also within the protection scope of the present disclosure.

According to some embodiments of the present disclosure, in response to the cooking appliance 100 being in the first cooking mode, the first heating element 21 may operate, but the second heating element 22 does not operate; and in response to the cooking appliance 100 being in the second cooking mode, the first heating element 21 may operate, and the second heating element 22 may operate. That is, the first heating element 21 is used in both the first cooking mode and the second cooking mode. In the second cooking mode, heating by the two heating elements can further increase the surface area in contact with the air and further improve the air-frying effect.

It is to be noted that here the operation of the first heating element 21 and the operation of the second heating element 22 should be understood broadly. That is, the first heating element 21 and the second heating element 22 can operate simultaneously, in one embodiment, or at a staggered time, etc., as long as the first heating element 21 and the second heating element 22 can heat the air in the accommodation chamber 101 in the second cooking mode.

In an embodiment of the present disclosure, the first heating element 21 may be a combination hot plate or IH, etc., and the second heating element 22 may be a heat pipe, infrared or hot plate, etc. The first heating element 21 and the second heating element 22 may be a combination of any two heating modes.

Other compositions as well as operations of the cooking appliance 100 according to the embodiments of the present disclosure are known and will not be described in detail herein.

In the description of the present disclosure, it should be noted that unless specified or limited otherwise, the terms “mounted,” “connected,” and “coupled” are understood broadly, such as fixed, detachable mountings, connections and couplings or integrated, and can be mechanical or electrical mountings, connections and couplings, and also can be direct and via media indirect mountings, connections, and couplings, and further can be inner mountings, connections and couplings of two components or interaction relations between two components.

In the description of the present disclosure, reference throughout this specification to “an embodiment”, “a specific embodiment”, “an example”, etc., means that a particular feature, structure, material, or characteristic described in connection with the embodiment or example is included in at least one embodiment or example of the present disclosure. The appearances of the above phrases in various places throughout this specification are not necessarily referring to the same embodiment or example of the present disclosure. Furthermore, the particular features, structures, materials, or characteristics may be combined in any suitable manner in one or more embodiments or examples.

1. A cooking appliance, having a first cooking mode and a second cooking mode, the cooking appliance comprising:
a pot assembly defining an accommodation chamber and provided with a heating assembly;
a pot lid assembly provided with a fan assembly configured to drive air in the accommodation chamber to flow; and
a first food container and a second food container, one of the first food container and the second food container being placed in the accommodation chamber, wherein:
in response to the cooking appliance being in the first cooking mode, the first food container is placed in the accommodation chamber; and
in response to the cooking appliance being in the second cooking mode, the second food container is placed in the accommodation chamber, and the second food container has a cooking chamber in communication with the accommodation chamber.

2. The cooking appliance according to claim 1, wherein the second food container has a top opening that is opened and opposite to the fan assembly.

3. The cooking appliance according to claim 1, wherein in response to the second food container being placed in the accommodation chamber, an air duct is formed between the second food container and the pot assembly, the heating assembly being located in the air duct.

4. The cooking appliance according to claim 3, wherein the second food container has an air passing hole at a bottom wall of the second food container, the cooking chamber being in communication with the air duct through the air passing hole.

5. The cooking appliance according to claim 4, wherein the second food container comprises:
a container body having the cooking chamber, the air passing hole being formed at a bottom wall of the container body; and
a shelf disposed in the cooking chamber and dividing the cooking chamber into an upper chamber and a lower chamber.

6. The cooking appliance according to claim 4, wherein:
the air duct comprises a first air duct located at a lower side of the bottom wall of the second food container and a second air duct located outside a peripheral wall of the second food container, the heating assembly being located in the first tar duct; and
the heating assembly comprises a first heating element configured to heat the first food container and/or the second food container.

7. The cooking appliance according to claim 6, wherein the heating assembly further comprises a second heating element configured to heat the first food container and/or the second food container, the second heating element being disposed below the first heating element.

8. The cooking appliance according to claim 6, wherein the first heating element is an annular heating plate and surrounds the air passing hole.

9. The cooking appliance according to claim 8, wherein the annular heating plate is provided with an air guide rib at a lower surface of the annular heating plate, the air guide rib extending in a radial direction of the annular heating plate.

10. The cooking appliance according to claim 8, further comprising:
an air guide member having a through hole, the annular heating plate surrounding the air guide member, and the second food container being supported by at least one of the first heating element and the air guide member.

11. The cooking appliance according to claim 7, wherein the first heating element is connected to a bottom wall of the accommodation chamber through a plurality of connection feet, the plurality of connection feet being arranged at intervals in a circumferential direction of the first heating element and surrounding the second heating element.

12. The cooking appliance according to claim 1, wherein the first food container has a bottom wall attached to the heating assembly.

13. The cooking appliance according to claim 1, wherein the pot lid assembly comprises a first pot lid assembly, and a second pot lid assembly that is provided with the fan assembly, wherein:
in response to the cooking appliance being in the first cooking mode, the first pot lid assembly covers the pot assembly; and
in response to the cooking appliance being in the second cooking mode, the second pot lid assembly covers the pot assembly.

14. The cooking appliance according to claim 13, wherein the second pot lid assembly has a transparent region.

15. A cooking appliance according to claim 1, wherein:
the first cooking mode is a pressure-cooking mode; and
the second cooking mode is an air-frying mode.
